(19) United States
(12) Patent Application Publication
(10) Pub. No.: US 2006/0229219 A1
(43) Pub. Date: Oct. 12, 2006

(54) Borate-polyol mixtures as a buffering system

(75) Inventors: Zhi-Jian Yu, Irvine, CA (US); Diane M. Croner, Tustin, CA (US)

Correspondence Address: Advanced Medical Optics, Inc.;Legal Department, 1700 E. St. Andrew Place, Santa Ana, CA, 92705, US

(73) Assignee: ADVANCED MEDICAL OPTICS, INC.

(21) Appl. No.: 11/104,233

(22) Filed: Apr. 11, 2005

(51) Int. Cl. C11D 3/00

(52) U.S. Cl. 510/112

(57) ABSTRACT

A buffering system having a pKa which may be selected based on the environment in which the solution is designed to be used. Solutions containing the buffering system according to the present invention include borate-polyol complexes as the primary buffering agents, and may include one or more of the following: an aqueous liquid medium; an antimicrobial component; a surfactant component; a viscosity-inducing component; and/or a tonicity component. The borate-polyol buffering system may be formulated to have a lower pKa than traditional systems.

### BACKGROUND OF THE INVENTION

1. Field of the Invention

The present invention relates to compositions and methods for formulating and using the same, and more particularly to compositions containing borate-polyol mixtures as the primary buffering agents.

2. Description of Related Art

Contact lenses must be disinfected and cleaned to kill harmful microorganisms that may be present or grow on the lenses, and to remove any buildup that may have accumulated on the lenses. Some of the most popular products for disinfecting lenses are multi-purpose solutions that can be used to clean, disinfect and wet contact lenses, followed by direct insertion (placement on the eye) without rinsing.

The ability to use a single solution for contact lens care is an advantage to many users. Such a solution must be strong enough to kill harmful microorganisms that may be present or grow on the lenses. It must also be particularly gentle to the eye, since at least some of the solution will be on the lens when inserted and will come into contact with the eye. Such a solution must also be compatible with all contact lens materials, particularly the silicone hydrogel materials, which represent the state-of-the-art contact lens materials.

A significant challenge to improving the disinfecting efficacy of a solution is to simultaneously improve or maintain its contact lens material compatibility and comfort. One important component of ophthalmic compositions is the buffer, which helps to maintain the pH of the composition within an acceptable physiological range.

Conventional buffers which are typically used in ophthalmic compositions suffer either from the problems of the interaction with quaternary ammonium based antimicrobial, which reduces its antimicrobial efficacy (such as phosphate butter) or from the problem that their pKa values (the ability of an ionizable group to donate a proton in an aqueous media) typically fall outside of acceptable physiological range. For example, borate buffers have a pKa of 9.0. This is clearly outside the desired ophthalmic pH range of 7.0-7.8. While this may be overcome by increasing the concentration of said buffer, this increase in concentration may not be desirable to users from a physiological viewpoint.

Similar problems are present with lens rewetting solutions and artificial tears.

It is known in the art to use borate-polyol complexes as antimicrobial agents. By way of example, this is taught by Chowhan et al., U.S. Pat. No. 6,849,253. However, this reference does not teach a buffering system having a pKa that may be selected for physiological compatibility based on the use for which the resulting solution will be used.

Thus, it would be desirable to develop a buffering system which may be designed to have a pKa that is tailored for physiological capability. For example, in ophthalmic solutions it would be desirable to have a buffering system having a pKa that provides a pH buffering capacity within the normal physiological range of approximately 7.0 to 7.8. Such system may be used in any composition in which a buffer having a pH buffering capacity within that range may be employed including, but not limited to, for example, multi-purpose contact-lens solutions, rewetters and artificial tears.

### DETAILED DESCRIPTION

A borate-polyol buffering system which may be designed to have a pKa that is significantly lower than that of boric/borate. Associated compositions and methods employing this buffering system according to the present invention provide improved, physiologically acceptable solutions and treatments, and for ease in formulating the same solutions and treatments.

The pKa of the buffering system according to the present invention may be selected based on the environment in which the solution is designed to be used. As a general statement, the larger the molar ratio of the polyol to boric acid, the higher the complexation. Since the buffering capacity is provided by the boric-polyol complex, the amount of the complex in solution affects the overall pKa value. That is, the larger the amount of complexes, the lower the pKa value. Similarly, the smaller the amount of the complex, the higher pKa value. Therefore the pKa value can be adjusted by changing the amount and the ratio of the boric acid and polyol. Therefore the buffer according to the present invention is unique in that it can provide a wide range of buffering capacities around physiological pH from 6-9.

As used herein, a polyol is an organic compound having two or more hydroxyl (—OH) group adjacent to each other.

As used herein, the term ‘boric acid’ is used to mean boric acid (H₃BO₃), metal salts of boric acid (MH₂BO₃), and borate (M₂B₄O₇), all of which will complex with polyols. Sodium salt of boric acid is one example of a metal salt of boric acid. Sodium borate is one example of borate. When the boric acid is complexed with the polyol, it is a borate-polyol complex. The concentration of borate-polyol complex in solutions according to the present invention ranges from about 0.005 to about 2% w/w, preferably from about 0.01% to about 0.5% w/w, and most preferably from about 0.04% to about 0.4% w/w.

The buffer component is present in an amount effective to maintain the pH of the composition or solution in the desired range, for example, in a physiologically acceptable range of about 4 or about 5 or about 6 to about 8 or about 9 or about 10. In particular, the solution preferably has a pH in the range of about 6 to about 8.

The present compositions preferably further comprise effective amounts of one or more additional components, such as one or more antimicrobial agent(s); detergent or surfactant component; a viscosity inducing or thickening component; a surfactant; a chelating or sequestering component; a tonicity component; and the like and mixtures thereof. Compositions according to the present invention may also include beneficial. amino acids. The additional component or components may be selected from materials which are known to be useful in contact lens care compositions and are included in amounts effective to provide the desired effect or benefit. When an additional component is included, it is preferably compatible under typical use and storage conditions with the other components of the composition. For instance, the aforesaid additional component or components preferably are substantially stable in the presence of the antimicrobial and buffer components described herein.

The compositions and methods of the present invention may be used to achieve stand-alone disinfection standards against four of the five FDA contact lens disinfection panel organisms (P. aeruginosa, S. aureus, S. marcescens and F. solani) and regimen disinfection against the fifth organism, C. albicans.

Antimicrobial components which may be used in association with the buffering system according to the present invention include chemicals which derive their antimicrobial activity from chemical or physiochemical interaction with microbes or microorganisms such as those contaminating a contact lens. Suitable additional antimicrobial components include, but are not limited to, those generally employed in ophthalmic applications such as quaternary ammonium salts such as poly [dimethylimino-2-butene-1,4-diyl] chloride, alpha-[4-tris(2-hydroxyethyl) ammonium]-dichloride (chemical registry number 75345-27-6, available under, the trademark Polyquatemium 1® from Onyx Corporation), benzalkonium halides, and biguanides, such as salts of alexidine, alexidine-free base, salts of chlorhexidine, hexamethylene biguanides and their polymers, and salts thereof, antimicrobial polypeptides, chlorine dioxide precursors, and the like and mixtures thereof. Generally, the hexamethylene biguanide polymers (PHMB), also referred to as polyaminopropyl biguanide (PAPB), have molecular weights of up to about 100,000. Such compounds are known and are disclosed in Ogunbiyi et al, U.S. Pat. No. 4,759,595, the disclosure of which is hereby incorporated in its entirety by reference herein.

Generally, the antimicrobial component is present in the liquid aqueous medium at an ophthalmically acceptable or safe concentration such that the user may remove the disinfected lens from the liquid aqueous medium and thereafter directly place the lens in the eye for safe and comfortable wear. Alternatively, the antimicrobial component is present in the liquid aqueous medium at an ophthalmically acceptable or safe concentration and sufficient for maintaining preservative effectiveness. The additional antimicrobial components useful in the present invention preferably are present in the liquid aqueous medium in concentrations in the range of about 0.00001% to about 0.01% (w/w), and more preferably in concentrations in the range of about 0.00005% to about 0.001% (w/w) and most preferably in concentrations in the range of about 0.00005% to about 0.0005% (w/w).

Antimicrobial components suitable for inclusion in the present invention include chlorine dioxide precursors. Specific examples of chlorine dioxide precursors include stabilized chlorine dioxide (SCD), metal chlorites, such as alkali metal and alkaline earth metal chlorites, and the like and mixtures thereof. Technical grade sodium chlorite is a very useful chlorine dioxide precursor. Chlorine dioxide containing complexes such as complexes of chlorine dioxide with carbonate, chlorine dioxide with bicarbonate and mixtures thereof are also included as chlorine dioxide precursors. The exact chemical composition of many chlorine dioxide precursors, for example, SCD and the chlorine dioxide complexes, is not completely understood. The manufacture or production of certain chlorine dioxide precursors is described in McNicholas, U.S. Pat. No. 3,278,447, which is incorporated in its entirety herein by reference. Specific examples of useful SCD products include that sold under the trademark Dura Klor® by Rio Linda Chemical Company, Inc., and that sold under the trademark Anthium Dioxide® by International Dioxide, Inc.

The polyquaternium-1 that may be used in the present invention may come in the form of a pure liquid, a liquid concentrate, a salt, or a salt in aqueous solution. One particularly useful form of polyquaternium-1 is polyquaternium-1 chloride in aqueous solution. Likewise, the PHMB that may be used in the present invention may come in the form of a pure liquid, a liquid concentrate, a salt, or a salt in aqueous solution. One particularly useful form of PHMB is a hydrochloride salt in aqueous solution at between 1 and 20 w/w %.

If a chlorine dioxide precursor in included in the present compositions, it generally is present in an effective preservative or contact lens disinfecting amount. Such effective preservative or disinfecting concentrations usually are in the range of about 0.002 to about 0.06% (w/w) of the present compositions. The chlorine dioxide precursors may be used in combination with other antimicrobial components, such as biguanides, biguanide polymers, salts thereof and mixtures thereof.

In the event that chlorine dioxide precursors are employed as antimicrobial components, the compositions usually have an osmolality of at least about 200 mOsmol/kg and are buffered to maintain the pH within an acceptable physiological range, for example, a range of about 6 to about 10.

In one embodiment, the additional antimicrobial component is non-oxidative. It has been found that reduced amounts of non-oxidative antimicrobial components, for example, in a range of about 0.1 ppm to about 3 ppm or less than 5 ppm (w/w), in the present compositions are effective in disinfecting contact lenses and reduce the risk of such antimicrobial components causing ocular discomfort and/or irritation. Such reduced concentration of antimicrobial component is very useful when the antimicrobial component employed is selected from biguanides, biguanide polymers, salts thereof and mixtures thereof.

Cetylpyridinium chloride (CPC) is an example of an antimicrobial agent that may be used in conjunction with the buffer system according to the present invention. One of the present inventors previously discovered that cetylpyridinium chloride (CPC) at low concentrations, in combination with a non-ionic poly(oxypropylene)-poly(oxyethylene) block copolymer surfactant, can be efficacious as a contact lens disinfection agent. Such efficacy may be seen in concentrations ranging from as low as 0.1 ppm or 0.3 ppm to about 8 ppm, 9 ppm or 10 ppm. The benefits which may be achieved through the use of CPC are disclosed in U.S. patent application Ser. No. 10/820,486, to Zhi-Jian Yu et al., entitled “Cetylpyridinium Chloride as an Antimicrobial Agent” which is incorporated herein by reference.

The viscosity-inducing components which may be employed in the present solutions preferably are effective at low or reduced concentrations, are compatible with the other components of the present solutions and are nonionic. Such viscosity inducing components are effective to enhance and/or prolong the cleaning and wetting activity of the surfactant component and/or condition a contact lens surface rendering it more hydrophilic (less lipophilic) and/or to act as a demulcent on the eye. Increasing the solution viscosity provides a film on the lens which may facilitate comfortable wearing of the treated contact lens. When the present buffering system is incorporated in a rewetter or multi-purpose solution, the viscosity-inducing component may also act to cushion the impact on the eye surface during insertion of the lens and serves also to alleviate eye irritation.

Suitable viscosity-inducing components include, but are not limited to, water soluble natural gums, gelatin, polyols (by way of example, and not of limitation, including glycerin, and propylene glycol) cellulose-derived polymers and the like. Useful natural gums include guar gum, gum tragacanth and the like. Useful cellulose-derived viscosity inducing components include cellulose-derived polymers, such as hydroxypropyl cellulose, hydroxypropylmethyl cellulose, methyl cellulose, hydroxyethyl cellulose, hyaluronate (HA) and the like. Polyethylene glycol 300, polyethylene glycol 400, and polysorbate 80 are also useful. More preferably, the viscosity-inducing agent is selected from cellulose derivatives (polymers) and mixtures thereof. A very useful viscosity inducing component is hydroxypropylmethyl cellulose (HPMC).

Additional demulcents include, but are not limited to, the approved ophthalmic demulcents described in the United States Ophthalmic Demulcents Monograph. See 21 CFR 349.12 (2003).

The present invention may also include hyaluronic acid (e.g., sodium hyaluronate) as the primary active demulcent ingredient. As one of ordinary skill in the art will know, a demulcent is an agent (usually a water soluble polymer) which is applied topically to the eye to protect and lubricate mucous membrane surfaces and relieve dryness and irritation. In this embodiment of the present invention, the hyaluronic acid preferably has a molecular weight of about 200,000 to about 4,000,000 daltons. Preferably, the range is from about 750,000 to about 2,000,000 daltons. More preferably, the range is from about 800,000 to about 1,750,000 daltons or from about 900,000 to about 1,500,000 daltons. In one embodiment, the concentration of hyaluronic acid is from about 0.005% to about 0.5% (w/w). Preferably, the hyaluronic acid concentration ranges from about 0.01 to about 0.3% w/w. In a more preferred embodiment, the hyaluronic acid concentration ranges from about 0.02 to about 0.2% w/w. In another preferred embodiment the concentration of hyaluronic acid is from about 0.05% to about 2% w/w, and more preferably from about 0.1 to about 0.5% w/w.

The viscosity-inducing component is used in an amount effective to increase the viscosity of the solution, preferably to a viscosity in the range of about 1.5 to about 30, or even as high as about 75 cps at 25° C., preferably as determined by USP test method No. 911 (USP 23, 1995). To achieve this range of viscosity increase, an amount of viscosity-inducing component of about 0.01% to about 5% (w/w) preferably is employed, with amounts of about 0.05% to about 0.5% or 0.2 to about 2.5 being more preferred.

A stabilized oxy-chloro complex may be used as a preservative. Preferably the stabilized oxy-chloro complex concentration ranges from about 0.0015 to about 0.05% w/w. More preferably the stabilized oxy-chloro complex concentration ranges from about 0.0025 to about 0.03% w/w. Another preferred stabilized oxy-chloro complex concentration ranges from about 0.003 to about 0.02% w/w. In a further preferred embodiment, the stabilized oxy-chloro concentration ranges from about 0.0035 to about 0.01% w/w. More preferably, the stabilized oxy-chloro complex concentration ranges from about 0.004 to about 0.009% w/w.

As used herein, the term “stabilized oxy-chloro complex” is a broad term used in its ordinary sense. The term includes, without limitation, a stable solution comprising a chlorine dioxide precursor or a chlorine dioxide precursor with chlorine dioxide in equilibrium. Chlorine dioxide precursors include, but are not limited to, chlorite components such as metal chlorites, for example alkali metal and alkaline earth metal chlorites. One particularly preferred metal chlorite is sodium chlorite. Stabilized oxy-chloro complex as stabilized chlorine dioxide is available commercially as OCUPURE™ from Advanced Medical Optics, Inc., PURITE® from Allergan, Inc., and PUROGENE from Biocide, Inc.

As used herein, concentrations of stabilized oxy-chloro complex are measured in terms of potential chlorine dioxide. Potential chlorine dioxide is a broad term, used in its ordinary sense. As such, one sense of the term refers to the amount of chlorine dioxide potentially provided if all chlorine dioxide precursor, such as sodium chlorite, were converted to chlorine dioxide. One way to convert sodium chlorite to chlorine dioxide is to dissolve the sodium chlorite and acidify the resulting solution. One of ordinary skill in the art will know of other means to convert sodium chlorite to chlorine dioxide including, but not limited to, exposure to transition metals.

The liquid aqueous medium preferably includes an effective amount of a tonicity component to provide the liquid medium with the desired tonicity. Among the suitable tonicity adjusting components that may be employed are those conventionally used in contact lens care products, such as various inorganic salts and non-ionic polyols (as one of ordinary skill in the art will realize, in the event that a non-ionic polyol is used, the concentrations of the buffering system will have to be adjusted). Sodium chloride and/or potassium chloride and the like are very useful tonicity components, as are propylene glycol, glycerin, sorbitol, mannitol and the like. The amount of tonicity component included is effective to provide the desired degree of tonicity to the solution. Such amount may, for example, be in the range of about 0.4% to about 1.5% (w/w). If a combination of sodium chloride and potassium chloride is employed, it is preferred that the weight ratio of sodium chloride to potassium chloride be in the range of about 3 to about 6 or about 8.

In another embodiment of the invention, the solution may comprise balanced salts. The balanced salts preferably include NaCl, KCl, CaCl₂, and MgCl₂ in a ratio that provides an osmolality range of about 140 to about 400, preferably about 240 to about 330 mOsm/kg, and even more preferably about 260 to about 300 mOsm/kg, with the most preferred osmolality of approximately 270 mOsm/kg. In one embodiment, NaCl ranges from about 0.1 to about 1% w/w, preferably from about 0.2 to about 0.8% w/w, and even more preferably about 0.39% w/w, KCl ranges from about 0.02 to about 0.5% w/w, preferably about 0.05 to about 0.3% w/w, more preferably about 0.14% w/r, CaCl₂ ranges from about 0.0005 to about 0.1% w/w, preferably about 0.005 to about 0.08% w/w, more preferably about 0.06% w/w, and MgCl₂ ranges from about 0.0005 to about 0.1% w/w, preferably about 0.005 to about 0.08% w/w, more preferably about 0.06% w/w.

A chelating or sequestering component preferably is included in an amount effective to enhance the effectiveness of the antimicrobial component and/or to complex with metal ions to provide more effective cleaning of the contact lens.

A wide range of organic acids, amines or compounds which include an acid group and an amine function are capable of acing as chelating components in the present compositions. For example, nitrilotriacetic acid, diethylenetriaminepentacetic acid, hydroxyethylethylene-diaminetriacetic acid, 1,2-diaminocyclohexane tetraacetic acid, hydroxyethylaminodiacetic acid, ethylenediamine-tetraacetic acid and its salts, polyphosphates, citric acid and its salts, tartaric acid and its salts, and the like and mixtures thereof, are useful as chelating components. Ethylenediaminetetraacetic acid (EDTA) and its alkali metal salts, are preferred, with disodium salt of EDTA, also known as disodium edetate, being particularly preferred.

The chelating component preferably is present in an effective amount, for example, in a range of about 0.01% and about 1% (w/w) of the solution.

In a very useful embodiment, particularly when the chelating component is EDTA, salts thereof and mixtures thereof, a reduced amount is employed, for example, in the range of less than about 0.05% (w/w) or even about 0.02% (w/w) or less. Such reduced amounts of chelating component have been found to be effective in the present compositions while, at the same time, providing for reduced discomfort and/or ocular irritation.

Beneficial amino acids may also be included in the present compositions. By way of example, and not of limitation, taurine, glycine and serine may be included. Taurine, which has been shown to serve a membrane protective function for ocular tissues, may be included in those embodiments of the present invention that will be used within the eye. The amount of amino acids which may be added to compositions according to the present invention is generally from about 0.0001 w/w % to about 0.1 w/w %.

The benefits of including taurine are disclosed in U.S. patent application Ser. No. 10/328,641, to S. Huth, entitled “Contact Lens Care Compositions, Methods of Use, and Preparation which Protect Ocular Tissue,” which is incorporated herein by reference. The amount of taurine useful in the present invention to maintain ocular tissue cell membrane integrity, particularly during contact lens wear, may be determined by objective clinical measures such as tear LDH release from corneal epithelial cells or fluorescein barrier permeability measurements or another means to evaluate ocular cell membrane integrity such as fluorescein or rose bengal staining. Yet another means to evaluate ocular cell membrane integrity is the use of confocal microscopy to measure epithelial cell area. In lieu of using tear LDH as a response factor, another inflammatory mediator may be measured in tears to indicate a beneficial effect from taurine. Useful amounts of taurine can also be determined by subjective clinical measures such as itching, lacrimation (tearing) and comfort. The amount of taurine useful in the present invention is generally from about 0.01 to about 2.0 w/w %, and may be from about 0.05 to about 1.00 w/w %.

A surfactant component preferably is present in an amount effective in cleaning, that is to at least facilitate removing, and preferably effective to remove, debris or deposit material from, a contact lens contacted with the surfactant containing solution.

The surfactant component preferably is nonionic, and more preferably is selected from poly (oxyethylene)-poly(oxypxopylene) block copolymers and mixtures thereof. Such surfactant components can be obtained commercially from the BASF Corporation under the trademarks Pluronic® or Tetronic®. Pluronic® block copolymers can be generally described as polyoxyethylene/polyoxypropylene condensation polymers terminated in primary hydroxyl groups. They may be synthesized by first creating a hydrophobe of desired molecular weight by the controlled addition of propylene oxide to the two hydroxyl groups of propylene glycol or glycerin. In the second step of the synthesis, ethylene oxide is added to sandwich this hydrophobe between hydrophile groups. Tetronic® surfactants are also known as poloxamines and are symmetrical block copolymers of ethylene diamine with polyoxyethylene and polyoxypropylene.

Examples of some non-ionic surfactants for use in the present invention are disclosed in, for example, Kirk-Othmer, Encyclopedia of Chemical Technology, 3rd Edition, Vol. 22 (John Wiley E Sons, 1983), Sislet & Wood, Encyclopedia of Surface Active Agents (Chemical Publishing Co., Inc. 1964), McCutcheon's Emulsifiers & Detergents, North American and International Edition (McCutcheon Division, The MC Publishing Co., 1991), Ash, The Condensed Encyclopedia of Surfactants (Chemical Publishing Co., Inc., 1989), Ash, What Every Chemical Technologist Wants to Know About . . . Emulsifiers and Wetting Agents, Vol. 1 (Chemical Publishing Co., Inc., 1988), Tadros, Surfactants (Academic Press, 1984), Napper, Polymeric Stabilization of Colloidal Dispersion (Academic Press, 1983) and Rosen, Surfactants & Interfacial Phenomena, 2nd Edition (John Wiley & Sons, 1989), all of which are incorporated herein by reference.

In accordance with a more preferred embodiment of the invention, such block copolymers having molecular weights in the range of about 2500 to 13,000 daltons are suitable, with a molecular weight range of about 6000 to about 12,000 daltons being still more preferred. Specific examples of surfactants which are satisfactory include: polbxamer 108, poloxamer 188, poloxamer 237, poloxamer 238, poloxamer 288 poloxamer 407, Tetronic® 1107, Tetronic®1304 (mwt 10,500), and Tetronic® 1307. Particularly good results are obtained with with poloxamer 237 and Tetronic® 1304. Poloxamer 237 is also known as Pluronic F87.

Alternative exemplary surfactant components include, but are not limited to, nonionic surfactants, for example, polysorbates (such as polysorbate 20-Trademark Tween 20), tocopherol polyethylene glycol succinate (“TPGS”), polyethylene glycol (PEG)-400, 4-(1,1,3,3-tetramethylbutyl) phenol/poly(oxyethylene) polymers (such as the polymer sold under the trademark Tyloxapol), poly(oxyethylene)-poly(oxypropylene) block copolymers, and the like, and mixtures thereof.

The amount of surfactant component, if any, present varies over a wide range depending on a number of factors, for example, the specific surfactant or surfactants being used, the other components in the composition and the like. Often, the amount of surfactant is in the range of about 0.005% or about 0.01% to about 0.1% or about 0.5% or about 1.0% (w/w). The preferred surfactant concentration is between about 0.05% and 0.20% (w/w).

When the present buffering system is used as an ophthalmic solution such as a multi-purpose solution, rewetter or tear, the liquid aqueous medium used is selected to have no substantial deleterious effect on the lens being treated, or on the wearer of the treated lens. The liquid medium is constituted to permit, and even facilitate, the lens treatment or treatments by the present compositions. The liquid aqueous medium advantageously has an osmolality in the range of at least about 200-mOsmol/kg to about 300 or about 350 mOsmol/kg. The liquid aqueous medium more preferably is substantially isotonic or hypotonic (for example, slightly hypotonic) and/or is ophthalmically acceptable.

In one embodiment, the present compositions comprise: a liquid aqueous medium, a borate-polyol buffer in an amount effective in maintaining the pH of the composition within a physiologically acceptable range, an antimicrobial agent in an amount effective to, in association with the remainder of the solution, disinfect a contact lens contacted with the composition; a non-ionic surfactant component in an amount effective in cleaning a contact lens contacted with the composition; an effective amount of a viscosity inducing component; and an effective amount of a tonicity component. The present compositions may also include an effective amount of a chelating or sequestering component, more preferably in a range of less than 0.05% (w/w). Each of the components, in the concentration employed, included in the solutions and the formulated solutions of the present invention generally are ophthalmically acceptable. In addition, each of the components, in the concentration employed included in. the present solutions usually is soluble in the liquid aqueous medium.

A solution or component thereof is “ophthalmically acceptable” when it is compatible with ocular tissue, that is, it does not cause significant or undue detrimental effects when brought into contact with ocular tissue. Preferably, each component of the present compositions is also compatible with the other components of the present compositions. The present compositions are more preferably substantially ophthalmically optimized. An ophthalmically optimized composition is one which, within the constraints of component chemistry, minimizes ocular response, or conversely delivers ophthalmic benefit to the lens-wearing eye.

When a contact lens is desired to be disinfected by the present compositions, an amount of an antimicrobial component(s) effective to disinfect the lens is added to the present compositions. Preferably, such an effective amount of the antimicrobial component reduces the microbial burden or load on the contact lens by one log order in three hours. More preferably, an effective amount of the disinfectant reduces the microbial load by one log order in one hour.

The presently useful additional antimicrobial components include chemicals which derive their antimicrobial activity through a chemical or physiochemical interaction-with microbes or microorganisms, such as those contaminating a contact lens. Suitable antimicrobial components are those generally employed in ophthalmic applications and include, but are not limited to: quaternary ammonium salts used in ophthalmic applications such as α-4-[1-tris(2-hydroxyethyl) ammonium-2-butenyl] poly[1-dimethylammonium-2-butenyl]-ω-tris (2-hydroxyethyl) ammonium chloride, (available under the trademark OnamerM® from Onyx Chemical Company, Jersey City, N.J.; also known as Polyquad® (Alcon Laboratories, Inc., Ft. Worth, Tex.); also known as polyquaternium-1), benzalkonium halides, and biguanides, such as salts of alexidine, alexidine-free base, salts of chlorhexidine, hexamethylene biguanides and their polymers, and salts thereof, antimicrobial polypeptides, and the like and mixtures thereof. Generally, the hexamethylene biguanide polymers (PHMB), also referred to as polyaminopropyl biguanide (PAPB), have molecular weights of up to about 100,000. Such compounds are known and are disclosed in Ogunbiyi et al, U.S. Pat. No. 4,759,595, the disclosure of which is hereby incorporated in its entirety by reference herein.

The antimicrobial components useful in the present invention preferably are present in the liquid aqueous medium in concentrations in the range of from about 0.00001% to about 0.05% (w/w), or from about 0.0001% o about 0.3% w/w.

More preferably, solution is formulated so that a user can remove the disinfected lens from the liquid aqueous medium and thereafter directly place the lens in the eye for safe and comfortable wear, with minimal, if any, incidence of corneal epithelial punctate fluorescein staining.

Additional buffer component(s) may optionally be included in solution. Such additional buffer component(s) may include one or more phosphate or tromethamine (TRIS, 2-amino-2-hydroxymethyl-1,3-propanediol) buffers, for example, combinations of monobasic phosphates, dibasic phosphates and the like, or tromethamine and tromethamine hydrochloride. Particularly useful phosphate buffers are those selected from phosphate salts of alkali and/or alkaline earth metals. Examples of suitable phosphate buffers include one or more of sodium phosphate dibasic (Na₂HPO₄), sodium phosphate monobasic (NaH₂PO₄) and the corresponding potassium phosphate salts. The buffer component may also include boric acid and its salt and/or sodium borate. The buffer component may also include an amino acid such as taurine. The present buffer components frequently are used in amounts in a range of about 0.01% or about 0.02% to about 0.5% (w/w), based upon buffer salt

When the buffer according to the present invention is used in a formulation designed to treat a contact lens, the formulation is selected to have no substantial deleterious effect on the lens being treated, or on the wearer of the treated lens. The liquid medium is constituted to permit, and even facilitate, the lens treatment or treatments by the present compositions. The liquid aqueous medium advantageously has an osmolality in the range of at least about 200-mOsmol/kg for example, about 300 or about 350 to about 400 mOsmol/kg. The liquid aqueous medium more preferably is substantially isotonic or hypotonic (for example, slightly hypotonic) and/or is ophthalmically acceptable.

Methods for treating a contact lens using the herein described compositions are included within the scope of the invention. Such methods comprise contacting a contact lens with such a composition at conditions effective to provide the desired treatment to the contact lens.

The contacting temperature is preferred to be in the range of about 0° C. to about 100° C., and more preferably in the range of about 10° C. to about 60° C. and still more preferably in the range of about 15° C. to about 30° C. Contacting at or about ambient temperature is very convenient and useful. The contacting preferably occurs at or about atmospheric pressure. The contacting preferably occurs for a time in the range of about 5 minutes or about 1 hour to about 12 hours or more.

A contact lens may be treated with a solution containing a buffer according to the present invention by immersing the lens in the solution. During at least a portion of the contacting, the liquid medium containing the contact lens can be agitated, for example, by shaking the container containing the liquid aqueous medium and contact lens, to at least facilitate removal of deposit material from the lens. After such contacting step, the contact lens may be manually rubbed to remove further deposit material from the lens. The cleaning method can also include rinsing the lens with the liquid aqueous medium or substantially free of the liquid aqueous medium prior to returning the lens to a wearer's eye. However, the method may also be as simple as contacting a lens with a solution, and placing the lens directly in an eye.

Various combinations of two or more of the above noted components may be used in providing at least one of the benefits described herein. Therefore, each and every such combination is included within the scope of the present invention.

The following non limiting examples illustrate certain aspects of the present invention.

### EXAMPLE 1

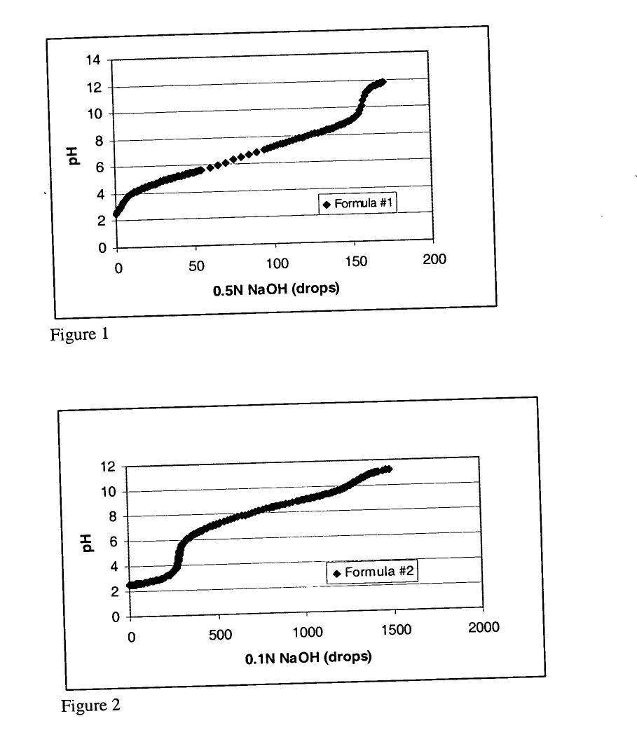

As discussed above, the borate-polyol buffering system according to the present invention may be designed to have a pKa that is significantly lower than those known in the art to date. FIGS. 1A and B display pH buffering profiles for mixtures of sorbitol and boric acid. The detailed formulations are listed in Table 1.

It can be seen that the pH buffering zone for Formulation #1, which has a lower borate-polyol concentration, is from 4.1 to 9.0, and the pH buffering zone for Formulation #2, which has a higher borate-polyol concentration, is from 6.5 to 9.7. The pKa values of the two formulas are 6.6 and 8.1, respectively (see Table 1).

The buffering system displayed in these solutions may be readily contrasted with the traditional boric acid buffer, which has been widely used in ophthalmic preparations. The weakness of the boric acid buffer is that its pKa (9.0) is far from the physiological pH range. To overcome this high pKa value, ophthalmic preparations usually require 10× more boric acid/borate buffer. Such high concentrations of the traditional boric acid buffer may yield high cytotoxicity to cornea cells.

The borate-polyol buffer presented above shows pKa values downshifted to a near-physiological pH value. Therefore, the concentration of borate/boric acid in solution can be lower than 0.06% and still show a strong buffering capacity at a pKa close to physiologically-acceptable ranges, as illustrated in FIGS. 1 and 2.

TABLE 1

Formulas

| | #1 | #2 |
|---|---|---|
| Component | % w/w | % w/w |
| Boric Acid | 0.115 | 0.06 |
| Sorbitol | 0.365 | 0.2 |
| HPMC | 0.2 | 0.2 |
| NaCl | 0.59 | 0.59 |
| KCl | 0.14 | 0.14 |
| EDTA | 0.01 | 0.01 |
| Taurine | 0.05 | 0.05 |
| Glycine | 0.0019 | 0.0019 |
| Serine | 0.0033 | 0.0033 |
| F87 | 0.05 | 0.05 |
| PEG 400 | 0.1 | 0.1 |
| CPC | 0.0002 | 0.0002 |
| Deionized water | Qs | Qs |
| pKa | 6.6 | 8.1 |

### EXAMPLE 2

The borate-polyol complex buffer according to the present invention has a wide buffering zone range and a pka value that may be adjusted to meet any pH buffering need for physiological compositions.

Table 2 shows the osmolality change when boric acid and sorbitol form complexes. The osmolality was measured using techniques well-known in the art. By way of example, osmolality may be measured using an osmometer such as the Advanced® 2020 Multi-Sample Osmometer (Advanced Instruments, Inc., Norwood, Mass., USA).

The third column of Table 2 shows the osmolality reduction in the solution which indicates the complex formation between boric acid/borate and sorbitol. Assuming 1:1 or 1:2 complexation ratio of boric acid to sorbitil (see fourth and fifth column of Table 2, respectively), the percent of the boric acid which complexes with the polyol is a small portion of the total boric acid available. The larger the molar ratio of sorbitol to boric acid, the higher the complexation. Since the buffering capacity is provided by the borate-sorbitol complex, the amount of the complex in solution affects the overall pKa value. That is, the larger the amount of complexes, the lower the pKa value. Similarly, the smaller the amount of the complex, the higher pKa value. Therefore the pKa value can be adjusted by changing the amount and the ratio of the boric acid and polyol. Therefore the buffer according to the present invention is unique in that it can provide a wide range of buffering capacities around physiological pH from 6-9.

TABLE 2

| | | | |
|---|---|---|---|
| | Osmo- | % Boric | % Boric |
| Osmo- | lality | Complexed | Complexed |
| lality | loss | (1:1 | (1:2 |
| (mOsm) | (mOsm) | complexation) | complexation) |

(No pH adjustment)

| | | | | |
|---|---|---|---|---|
| 3.64% Sorbitol | 204 | | | |
| 0.61% Boric acid | 96 | | | |
| 0.61% Boric + | 184 | 14.1 | 14.7 | 7.3 |
| 1.82% Sorbitol | | | | |
| 0.61% Boric + | 278 | 21.7 | 22.6 | 11.3 |
| 3.64% Sorbitol | | | | |

(pH adjusted to 8.0 with 0.5N NaOH)

| | | | | |
|---|---|---|---|---|
| 3.64% Sorbitol | 204 | | | |
| 1.82% Sorbitol | 99 | | | |
| 0.61% Boric acid | 99.5 | | | |
| 0.61% Boric + | 173 | 25.5 | 25.6 | 12.8 |
| 1.82% Sorbitol | | | | |
| 0.61% Boric + | 267 | 36.5 | 36.7 | 18.3 |
| 3.64% Sorbitol | | | | |

### EXAMPLE 3

The disadvantage of a traditional boric acid buffer for a contact lens cleaning, disinfecting, rewetting, and/or storage solution is that it can swell some types of contact lenses. An example of such a contact lens is the Aquavision lens (formerly the Actisoft lens (Bahrain Optics Co W.L.L.)). With the Aquavision lens, it is believed that the borate (either alone or mixed with boric acid) buffer swells contact lenses containing polyol groups in the lens materials.

In contrast to traditional boric acid buffers, borate-polyol complex buffers according to the present invention do not swell any contact lenses that are currently on the market.

Table 3 illustrates effect of five solutions on the Actisoft lens: the first 3 contain a traditional boric acid buffer, while the last 2 contain a buffer according to the present invention. As shown by Solution 3, a boric acid buffer may swell a lens as much as 0.57 mm. Sodium borate also swells Aquavision® lenses as much as 0.3 mm (Solution 1). Although in the third column, 0.1% glycerin was added to complex with the borate, the excess amount of borate in the solution still significantly swelled the lens.

The FDA criteria for contact lens solution maintenance is that the lens diameter change is within 0.2mm. This limits the application of boric acid for contact lens maintenance purposes.

In Table 3, Solutions 4 and 5 may be contrasted with Solutions 1-3. Solutions 4 and 5 show a borate-polyol buffer system without a significant excess of borate/boric acid does not swell the Aquavision® contact lenses.

TABLE 3

| | 1. | 2. | 3. | 4. | 5. |
|---|---|---|---|---|---|
| Component | % w/w | % w/w | % w/w | % w/w | % w/w |
| Na2B4O7*10H2O | 0.76 | 0.76 | 0.0 | 0.0 | 0.0 |
| Boric Acid | 0.0 | 0.0 | 0.60 | 0.12 | 0.06 |
| NaOH (1N) | 0.0 | 0.0 | 0.68 | 0.69 | 0.69 |
| NaCl | 0.6 | 0.6 | 0.59 | 0.59 | 0.59 |
| Glycerin | 0.0 | 0.1 | 0.0 | 0.0 | 0.0 |
| Sorbitol | 0.0 | 0.0 | 0.0 | 0.2 | 0.364 |
| PEG 400 | 0.0 | 0.0 | 0.1 | 0.1 | 0.1 |
| KCl | 0.14 | 0.14 | 0.14 | 0.14 | 0.14 |
| EDTA | 0.01 | 0.01 | 0.01 | 0.01 | 0.01 |
| Taurine | 0.05 | 0.05 | 0.05 | 0.05 | 0.05 |
| Pluronic F87 | 0.05 | 0.05 | 0.05 | 0.05 | 0.05 |
| Glycine | 0.0019 | 0.0019 | 0.0019 | 0.0019 | 0.0019 |
| Serine | 0.0033 | 0.0033 | 0.0033 | 0.0033 | 0.0033 |
| HPMC | 0.15 | 0.15 | 0.15 | 0.15 | 0.15 |
| Actisoft ® | 0.3 | 0.28 | 0.57 | 0.06 | −0.02 |
| lenses | | | | | |
| Swelling (mm) | | | | | |

### EXAMPLE 4

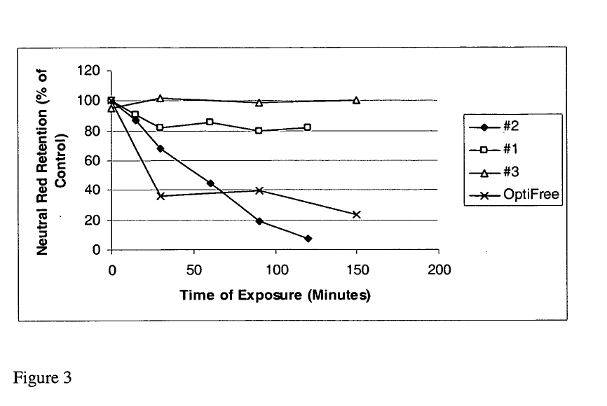

The borate-polyol complex buffer according to the present invention is non-cytotoxic. FIG. 3 shows the cytotoxicity result of four formulations, the formulas for the three formulations are listed in Table 4. The fourth formula is commercially-available Opti-free® (Alcon Laboratories, Forth Worth, Tex., USA). The Opti-free solution is known to contain a boric acid buffer.

The neutral red retention is a measure of the live mammal cells when in contact with the product.

Large amounts of borate-polyol complexes (larger than 0.5%) are known have antimicrobial activity. This antimicrobial activity, however, is a double-edged sword. While it may be effective against undesirable microbes, it can also induce cytotoxicity to the corneal cell. This cytotoxicity is illustrated by formula #2 and OptiFree (see FIG. 3), which contains more that 0.5% of mannitol-borate. As may be seen, the neutral red retention for formula #2 and OptiFree sharply decreases over even the first hour of exposure.

The borate-polyol buffer according to the present invention (Formula #3) shows very little cytotoxicity, even lower than boric acid alone (Formula #1). Therefore, it is expected that the borate-polyol buffer system according to the present invention would be non-irritating in the ophthalmic preparations with a strong buffering capacity.

TABLE 4

| | Formulation | | |
|---|---|---|---|
| | #1 | #2 | #3 |
| | % w/w | % w/w | % w/w |
| Boric Acid | 0.6 | 0.6 | 0.06 |
| Sodium Borate | 0.035 | 0.035 | |
| Sorbitol | | | 0.2 |
| Glycerin | | 1 | |
| KCl | 0.14 | 0.14 | 0.14 |
| Pluronic F87 | | | 0.05 |
| Tween-80 | 0.25 | 0.25 | |
| Edetate Disodium | | | 0.01 |
| Polyquaternium-1 | | | 0.00006 |
| Cetylpyridinium | | | |
| Chloride | | | 0.000125 |
| NaCl | for osmolality adjustment | | |
| Osmolality | 286 | 263 | 255 |
| pH | 7.4 | 7.7 | 7.7 |

### EXAMPLE 5

Two different formulations utilizing the borate-polyol buffering system according to the present invention were formulated by dissolving the ingredients in Table 5 in deionized water.

The resulting pH for both solutions was 7.7 and the solution osmolality was between 250-270 mOsm/kg. Antimicrobial activity was tested against the FDA contact lens disinfection panel using techniques that are well known in the art. Log reductions at 6 hours solution contact are reported in Table 6. As may be seen, both solutions meet the stand-alone disinfection efficacy standards.

Note that in this and the other examples, the ingredient concentrations are expressed in w/w %. However, given that multi-purpose solution density herein is essentially equal to 1.00 gm/mL, these w/w % concentrations are essentially equal to w/w % concentrations.

TABLE 5
Borate-sorbitol buffer in cleaning, disinfecting,
storing and rewetting solutions.

Solution

| | 1 | 2 |
|---|---|---|
| Component | % w/w | % w/w |
| CPC | 0.00015 | 0.0002 |
| Sodium Hyaluronate | 0.075 | |
| HPMC | | 0.2 |
| Taurine | 0.05 | 0.05 |
| PEG 400 | 0.1 | 0.1 |
| F87 | 0.05 | 0.05 |
| EDTA | 0.01 | 0.01 |
| Boric Acid | 0.06 | 0.06 |
| Sorbitol | 0.2 | 0.2 |
| NaOH (5N) | 0.12 | 0.12 |
| Glycine | 0.0019 | 0.0019 |
| Serine | 0.0033 | 0.0033 |
| NaCl | 0.59 | 0.59 |
| KCl | 0.14 | 0.14 |
| Deionized water | Qs | Qs |
| pH | 7.7 | 7.7 |

TABLE 6
Antimicrobial Efficacy of Solutions of Table 5
6 hour log drop

| | | |
|---|---|---|
| S. marcescens13880 | 3.49 | 4.02 |
| S. aureus 6538 | 4.19 | 3.41 |
| P. aeruginosa 9027 | 4.83 | 4.83 |
| C. albicans 10231 | 2.72 | 3.85 |
| F. solani36031 | 1.61 | 2.13 |

### EXAMPLE 6

A solution is prepared by blending together the components provided in Table 5, solution 1. Approximately three (3) mL of this solution is introduced into a lens case containing a lipid, oily and protein-deposit laden, hydrophilic or soft contact lens. The contact lens is maintained in this solution at room temperature for at least about four (4) hours. This treatment is effective to disinfect the contact lens. In addition, it is found that a substantial portion of the deposits previously present on the lens has been removed. This demonstrates that this solution has substantial passive contact lens cleaning ability. Passive cleaning refers to the cleaning which occurs during soaking of a contact lens, without mechanical or enzymatic enhancement.

After this time, the lens is removed from the solution and is placed in the lens wearer's eye for safe and comfortable wear. Alternately, after the lens is removed from the solution, it is rinsed with another quantity of this solution and the rinsed lens is then placed in the lens wearer's eye for safe and comfortable wear.

### EXAMPLE 7

Example 6 is repeated except that the lens is rubbed and rinsed with a different quantity of the solution prior to being placed in the lens vial. This treatment is effective to disinfect the contact lens. In addition, it is found that a substantial portion of the deposits previously present on the lens has been removed. After at least about four (4) hours, the lens is removed from the solution. The lens is then placed in the lens wearer's eye for safe and comfortable wear.

### EXAMPLE 8

The solution of Example 6 is used as a long-term soaking medium for a hydrophilic contact lens. Thus, approximately three (3) mL of this solution is placed in a vial and a contact lens is maintained in the solution at room temperature for about sixty (60) hours. After this soaking period, the lens is removed from the solution and placed in the lens wearer's eye for safe and comfortable wear. This treatment is effective to disinfect the contact lens. In addition, it is found that a substantial portion of the deposits previously present on the lens has been removed. Alternately, after the lens is removed from the solution, it is rinsed with another quantity of this solution and the rinsed lens is then placed in the lens wearer's eye for safe and comfortable wear.

### EXAMPLE 9

A hydrophilic contact lens is ready for wear. In order to facilitate such wearing, one or two drops of the solution of Example 6 are placed on the lens immediately prior to placing the lens in the lens wearer's eye. The wearing of this lens is comfortable and safe.

### EXAMPLE 10

A lens wearer wearing a contact lens applies one or two drops of the solution of Example 6 in the eye wearing the lens. This effects a re-wetting of the lens and provides for comfortable and safe lens wear.

The above invention has been described with an emphasis in use in the ophthalmic field. Such description of use is provided by way of example only. It will be understood by one of ordinary skill in the art that the buffering system according to the present invention is suitable for use in a variety of different situations and in a variety of different types of solutions. Thus, while this invention has been described with respect to various specific examples and embodiments, it is to be understood that the invention is not limited thereto and that it can be variously practiced within the scope of the following claims.

What is claimed is:

1. A solution comprising:
an aqueous liquid medium; and
from about 0.005% w/w to about 0.47% w/w of a buffering component comprising a borate-polyol complex.

2. The solution according to claim 1, wherein the solution comprises from about 0.01 to about 0.3% w/w of the borate-polyol complex.

3. The solution according to claim 1, wherein the solution comprises from about 0.04 to about 0.4% w/w of the borate-polyol complex.

4. The solution according to claim 1, wherein the borate-polyol complex has a pKa that is in the range from 6-9.

5. The solution according to claim 1, wherein the borate-polyol complex has a pKa that is selected by controlling an amount of the borate-polyol complex in the solution.

6. The solution according to claim 1, wherein the polyol is sorbitol.

7. The solution as in claim 1, further comprising a surfactant in an amount effective to clean a contact lens contacted with said solution.

8. The multi-purpose solution of claim 1, wherein said surfactant is selected from the group consisting of poly (oxyethylene)-poly(oxypropylene) block copolymers and mixtures thereof, and is present in an amount in a range of about 0.01% to about 1.0% (w/w).

9. The solution as in claim 1, further comprising a viscosity-inducing component selected from the group consisting of cellulosic derivatives and mixtures thereof in the range of about 0.05% to about 5.0% (w/w) of the total solution.

10. The multi-purpose solution of claim 1, wherein said viscosity-inducing component is hydroxypropylmethyl cellulose.

11. The solution as in claim 1, further comprising a chelating component in an amount of less than 0.05% (w/w) of the total solution.

12. The multi-purpose solution of claim 1, wherein said chelating component is EDTA.

13. The solution as in claim 1, further comprising a tonicity component in an amount effective in providing the desired tonicity to said solution.

14. The multi-purpose solution of claim 1, wherein said tonicity component comprises a combination of sodium chloride and potassium chloride and is present in a range of about 0.4% to about 1.5% (w/w).

15. The solution of claim 1, further comprising hyaluronic acid in amount ranging from about 0.005% to about 1.5% (w/w).

16. A solution comprising:
an aqueous liquid medium; and
a buffering component comprising a borate-polyol complex, wherein a pKa of the buffering component is in a pH range of from about 6 to about, 9 and further wherein the pKa is determined by an amount of the borate-polyol complex in the solution.

17. The solution according to claim 16, wherein the solution comprises from about 0.01 to about 0.3% w/w of the borate-polyol complex.

18. The solution according to claim 16 wherein the solution comprises from about 0.04 to about 0.4% w/w of the borate-polyol complex.

19. The solution according to claim 16, wherein the polyol is sorbitol.

20. The solution as in claim 16, further comprising a surfactant in an amount effective to clean a contact lens contacted with said solution.

21. The multi-purpose solution of claim 16, wherein said surfactant is selected from the group consisting of poly (oxyethylene)-poly(oxypropylene) block copolymers and mixtures thereof, and is present in an amount in a range of about 0.01% to about 1.0% (w/w).

22. The solution as in claim 16, further comprising a viscosity-inducing component selected from the group consisting of cellulosic derivatives and mixtures thereof in the range of about 0.05% to about 5.0% (w/w) of the total solution.

23. The multi-purpose solution of claim 16 wherein said viscosity-inducing component is hydroxypropylmethyl cellulose.

24. The solution as in claim 16, further comprising a chelating component in an amount of less than 0.05% (w/w) of the total solution.

25. The solution of claim 16, wherein said chelating component is EDTA.

26. The solution as in claim 16, further comprising a tonicity component in an amount effective in providing the desired tonicity to said solution.

27. The solution of claim 16, wherein said tonicity component comprises a combination of sodium chloride and potassium chloride and is present in a range of about 0.4% to about 1.5% (w /w).

28. The solution of claim 16, further comprising hyaluronic acid in amount ranging from about 0.005% to about 1.5% (w/w).

29. A method of formulating a solution containing a buffering system having a selected pKa, the method comprising:
combining boric acid and a polyol in aqueous solution to form a borate-polyol buffering system, wherein the pKa of the buffering system is selected by controlling an amount of the borate-polyol complex in the solution.

30. The method according to claim 29, wherein the selected pKa is in the range from 6-9.

31. The solution according to claim 29, wherein the buffering system generates a buffering capacity in the pH range from 6-9.

32. The method according to claim 29, wherein the polyol is sorbitol.

33. The method according to claim 29, wherein the concentration of borate-polyol complex in solution is from about 0.01% w/w to about 1% w/w.

34. The method according to claim 29, wherein the ratio of the borate:polyol in solution admixture is from about 100:1 to about 0.01:1.
